(19) United States
(12) Patent Application Publication
(10) Pub. No.: US 2002/0126480 A1
(43) Pub. Date: Sep. 12, 2002

(54) Warning device capable of emitting light

(76) Inventor: Hsi-Hui Chang, Tai Ping City (TW)

Correspondence Address: Raymond Yat Chan, 1050 Oakdale Lane, Arcadia, CA, 91006, US

(21) Appl. No.: 09/802,801

(22) Filed: Mar. 7, 2001

(51) Int. Cl. F21V 5/00

(52) U.S. Cl. 362/244; 362/240

(57) ABSTRACT

A warning device comprises a hollow tubular body in which a plurality of electrically-driven light emitting elements arm disposed in such a manner that the light emitting elements are controlled by an integrated circuit. In light of the radian of the pliable and light-transmitting tubular body, light emitted by the light emitting elements is so diffused as to brighten the tubular body on its entirety. The waxing device is thus made conspicuous by the tubular body.

### FIELD OF THE INVENTION

The present invention relates generally to a warning device, and more particularly to a warning device comprising a plurality of light-emitting elements, which are electrically driven and are arranged in combination in a hollow tubular body of a thermosetting plastic material. The hollow tubular body is soft, expandable, and pervious to light, the light-emitting elements are controlled by an integrated circuit, which is driven by a direct current dry battery. The radian of the tubular body enhances the diffusion of light emitted by the light-emitting elements, thereby resulting in improvement on the clarity of the warning device.

### BACKGROUND OF THE INVENTION

The U.S. Pat. No. 5,249,106 discloses a warning device, which comprises an acrylic rod for holding a light bulb. The acrylic rod is not a built-in component and is installed on a site where the warning device is located. This prior art warning device is therefore not cost-effective. In addition, the acrylic rod cannot be bent to conform to the shape and the size of the warning device. The use of the acrylic rod in the device is therefore limited.

Another U.S. Pat. No. 5,879,076 discloses a warning device, which comprises a pliable solid body for holding a cluster of light bulbs. The solid body is not cost-effective and must be replaced in its entirety. In addition, the quality control of the solid body is costly.

### SUMMARY OF THE INVENTION

The primary objective of the present invention is to provide a warning device, which is cost-effective and is formed of a light-emitting diode (LED) bulb 30, as shown in FIG. 1. The light-emitting diode bulb 30 emits light at an angle of α°. The LED bulb 30 is embedded in a hollow cylindrical body 20 of a plastic material such that the light emitted by the LED bulb 30 is diffused through the cylindrical body to form a light beam greater in light intensity and the illumination distance. As a result, the cylindrical body 20 has brightness, which is several times greater than that of the LED bulb 30. The present invention can be easily made at a low cost In addition, the damaged or burnout LED bulb can be easily replaced.

It is another objective of the present invention to provide a warning device comprising a plurality of light-emitting elements, which are electrically driven and are housed in a hollow tubular body of a thermoplastic material. The tubular body is soft, expandable, and pervious to light. The operation of the light-emitting elements is regulated by an integrated circuit driven by a direct current dry battery. In light of the radian of the tubular body, the light emitted is effectively diffused, thereby enabling the tubular body to become a light-emitting body which serves to make the waning device more conspicuous.

It is still another objective of the present invention to provide a warning device comprising an electrically-driven light-emitting element which is housed in a soft, expandable and light-pervious tubular body of a thermoplastic material in such a manner that the light-emitting element is provided with a beam splitter to bring about a projection coaxial with the tubular body. The tubular body becomes in its entirety a light-emitting body.

It is still another objective of the present invention to provide a warning device comprising an electrically driven light-emitting element, which is housed in a soft, expandable, and light-pervious tubular body of a thermoplastic material. The tubular body becomes in its entirety a light-emitting body by the light-focusing effect of a light-transmitting element.

It is still another objective of the present invention to provide a warning device which is pliable and is externally provided with two retaining elements for retaining the warning device on human body, vehicle, animal, fixed structure, or object in need of warning effect.

### BRIEF DESCRIPTION OF TIE DRAWINGS

FIG. 1 shows a schematic view of a light beam of the LED bulb housed in the hollow cylindrical body of the present invention.

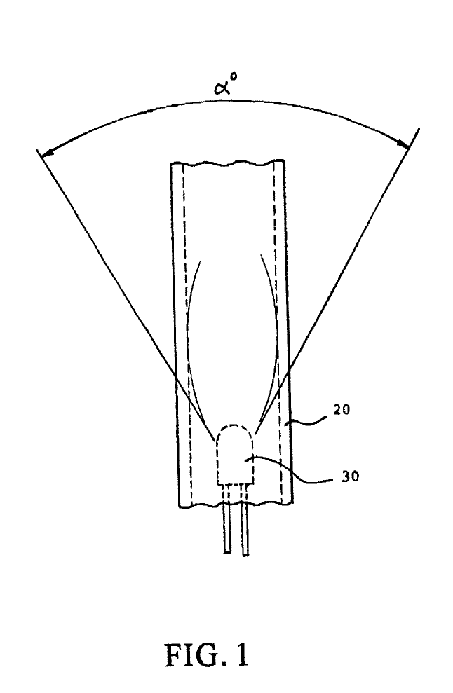

FIG. 2 shows an exploded view of a first preferred embodiment of the present invention.

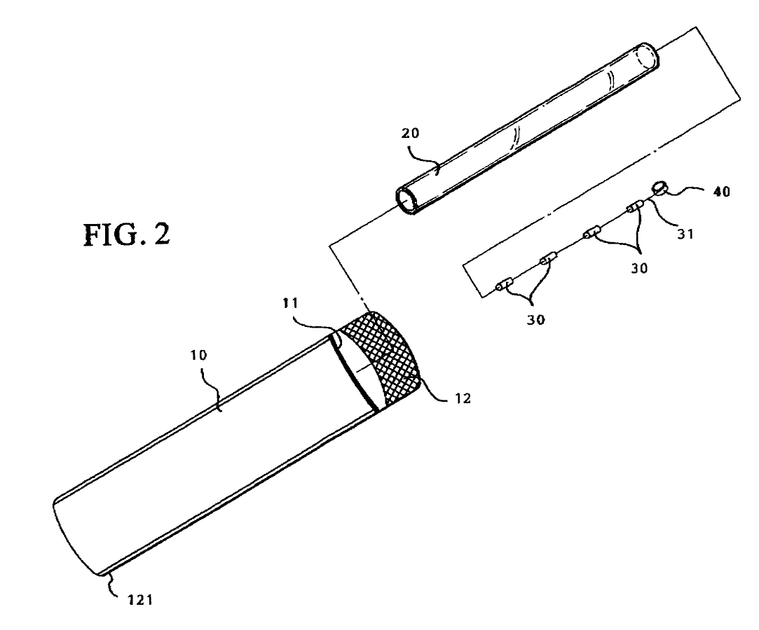

FIG. 3 show a plan view of the first preferred embodiment of the present invention in combination.

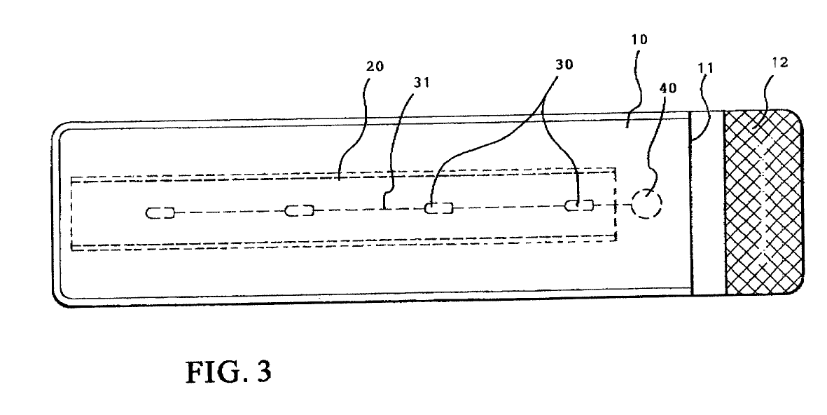

FIG. 4 show a perspective view of the first preferred embodiment of the present invention in combination.

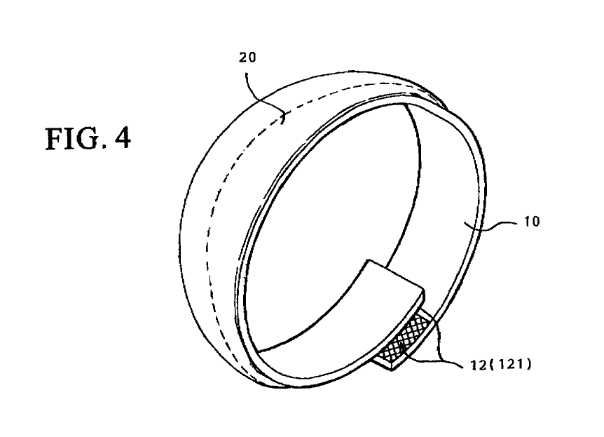

FIG. 5 show a plan view of a second preferred embodiment of the present invention in combination.

FIG. 6 shows a plan view of a third preferred embodiment of the present invention in combination.

### DETAILED DESCRIPTION OF THE PREFERRED EMBODIMENTS

As shown in FIGS. 24, the present invention comprises a warning device 10, a light-transmitting element 20, a plurality of light-emitting elements 30, and an electric apparatus 40.

The warning device 10 is a hollow bag body having a bag opening 11. a hook tape Velcro) 12, and a pile tape (Velcro) 121 complementary to the hook tape 12 for easy fastening and unfastening the warning device 10.

The light-transmitting element 20 is of a hollow tubular construction and is made of a thermoplastic material. The light-transmitting element 20 has a high transmittance, The light-transmitting element 20 is soft and expandable. The light-transmitting element 20 is put into the warning device 10 via the bag opening 11 of the waning device 10.

The light-emitting elements 30 are light-emitting diode (LED) bulbs which arc serially arranged by a bonding wire 31 and arm disposed in the light-transmitting element 20.

The electric apparatus 40 is formed of a battery, a power source switch, and a drive circuit. The electric apparatus 40 is connected with the bonding wire 31.

The warning device 10 is fastened to an object by means of the hook tape 12 and the pile tape 121.

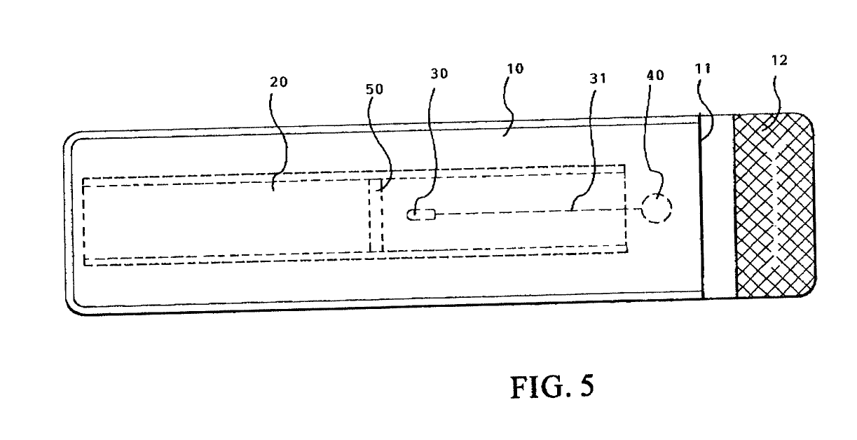

As shown in FIG. 5, a warning device of the present invention comprises a hollow bag body 10, a light transmitting element 20, a light-emitting element 30, and a beam splitter 50.

The hollow bag body 10 has an opening 11, a hook tape Velcro) 12 located at one end of the bag body 10, and a pile tape (Velcro) 121 located at other end of the bag body 10 such that the pile tape 121 is complementary to the book tape 12 for fastening and unfastening the bag body 10.

The light-transmitting element 20 is made of a thermoplastic material having pliability and a high transmittance. The light-transmitting element 20 is put into the bag body 10 via the opening 11 of the bag body 10.

The light-emitting element 30 is a light-emitting diode (LE)) bulb, which is disposed in the light-transmitting element 20 such that the LED bulb 30 is serially connected with an electric apparatus 40 comprising a battery, a power source switch, and a drive circuit.

The beam splitter 50 is an optical lens having a 50% light permeability and a 50% light reflectivity. The beam splitter 50 is disposed in the light-transmitting element 20 such that the bean spltter 50 is located at one end of the light-emitting element 30. The light emitted by the light-emitting element 30 is projected in the direction corresponding to the axial direction of the light-transmitting element 20, thereby enabling the light-transmitting element 20 to become a light-emitting body.

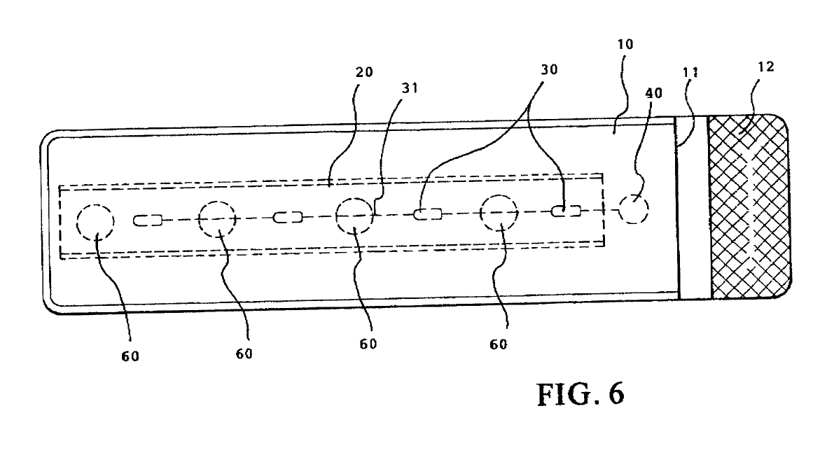

As shown in FIG. 6, a warning device of the present invention comprises a hollow bag body 10, a light transmitting element 20, a light-emitting element 30, and a light-permeating element 60.

The hollow bag body 10 has an opening 11, a hook tape (Velcro) 12 located at one end of the bag body 10, and a pile tape (Velcro) 121 located at other end of the bag body 10 such that the pile tape 121 is complementary to the hook tape 12 for fastening and unfastening the bag body 10.

The light-transmitting element 20 is made of a thermoplastic, material having pliability and a high transmittance. The light-transmitting element 20 is put into the bag body 10 via the opening 11 of the bag body 10.

The light-emitting element 30 is a LED bulb, which is disposed in the light-transmitting element 20 such that the LED bulb 30 is connected by a bonding wire 31 to an electric apparatus 40 comprising a battery, a power source switch, and a drive circuit.

The light-permeating element 60 is convex or spherical and has a high light permeability and a light focusing reflectivity. The light-permeating element 60 is disposed in the light-transmitting element 20 such that the light-permeating element 60 is separated from the light-emitting element 30 by an appropriate distance.

As the bag body 10 is fastened with an object by the hook tape 12 and the pile tape 121, the light emitted by the light-emitting element 30 is projected by the light-permeating element 60 to enable the light-transmitting element 20 to become a light-emitting body.

The light-emitting elements are disposed in a hollow tubular body of a thermoplastic material having pliability, a light permeability and a transmittance. The light emitted by the light-emitting elements is guided by the radian of the tubular body to diffuse, thereby enabling the tubular body to become a light-emitting body.

The present invention is provided with a beam splitter, which is located at one end of the light-emitting element to bring about a projection coaxial with the tubular body.

The present invention is provided with a light-permeating element of a convex or spherical construction to enable the light emitted by the light-emitting element to focus and project, thereby enabling the tubular body to become a light-emitting body.

What is clamed is:

1. A warning device comprising:
a hollow bag body having an opening and at least one fastening tape;
a light transmitting element made of a thermoplastic material having a pliability, a light permeability and a high transmittance, said light transmitting element being disposed in said hollow bag body; and
a plurality of LED bulbs connected serially by a bonding wire to an electric apparatus comprising a battery, a power source switch, and a drive circuit said LED bulbs being disposed in said light transmitting element.

2. The warning device as defined in claim 1, wherein said LED bulbs are provided at one end with a beam splitter, which is an optical lens having a 50% light permeability and a 50% light reflectivity.

3. The warning device as defined in claim 1. wherein said ED bulbs are provide with a light-permeating element of a convex or spherical construction.
